(19) United States
(12) Patent Application Publication
(10) Pub. No.: US 2013/0151412 A1
(43) Pub. Date: Jun. 13, 2013

(54) METHODS AND APPARATUSES FOR HANDLING A ROAD-USE-DEPENDENT VEHICLE COMMUNICATION

(71) Applicant: Ford Global Technologies, LLC, Dearbon, MI (US)

(72) Inventors: Robert Spahl, Koeln (DE); Torsten Gerhardt, London (GB)

(73) Assignee: FORD GLOBAL TECHNOLOGIES, LLC, Dearborn, MI (US)

(21) Appl. No.: 13/708,853

(22) Filed: Dec. 7, 2012

(30) Foreign Application Priority Data
Dec. 8, 2011 (DE) 102011087959.5

(51) Int. Cl. G06Q 20/40

(52) U.S. Cl. CPC G06Q 20/40
USPC 705/44

(57) ABSTRACT

A system and method for handling a road-use-dependent communication, such as a financial transaction, the execution of an overtaking maneuver is sensed and on the basis of the overtaking maneuver which has been performed a financial transaction is executed by an overtaking road user for an overtaken road user.

### RELATED APPLICATIONS

The present application claims priority to German Patent Application No. 102011087959.5, filed on Dec. 8, 2011, the entire contents of which are hereby incorporated by reference for all purposes.

### FIELD

The present description relates to a systems and methods for handling road-use-dependent vehicle communications.

### BACKGROUND AND SUMMARY

Methods and apparatuses for collecting road-use-dependent charges for the purpose of financing the road network (e.g., toll ways) and also for controlling the flow of traffic (e.g., toll expressways) are known. In this context, by way of example, toll charges are collected for the use of a toll-incurring section of road, said toll charges being paid upon entering the toll-incurring section of road or upon leaving the relevant section of road.

Weichmann (DE 4,112,472 A1) addresses the issue of enforcing speed limits through tolling. Accordingly, Weichmann discloses a toll system that senses the speed of individual road users, wherein deviations from an advisory speed limit result in an increase in the toll charges. In this manner, speed limits can be more strongly enforced since toll charges increase as a vehicle speed increases above an advisory speed limit.

The inventors herein have recognized potential issues with the conventional tolling approaches. Namely, the above-described conventional road-use-dependent financial transactions and tolling methods do not differentiate individual vehicles and their drivers' travelling requirements. In particular conventional tolling methods administer tolls solely via telecommunication between individual vehicles and the tolling system, however there is no system for vehicle-to-vehicle (V2V) tolling. For example, in a traffic-congested toll way, certain drivers may be in a hurry and desire to travel faster, while other drivers may be satisfied with travelling at a slower speed (e.g., congested traffic speed). However there is no system or process by which a driver of a vehicle who wishes to travel faster can communicate with another vehicle driver to concede the right-of-way (ROW) in exchange for payment of a V2V toll to the conceding driver.

One approach that addresses the aforementioned issues is a system and method whereby road-use-dependent communications, for example, transactions, can be conducted between a first vehicle and a second vehicle, when a second vehicle concedes ROW to the first vehicle. For example, a predetermined toll or fee, based on the travelling conditions of the first and second vehicles, can be transferred from an account associated with the first vehicle to an account associated with the second vehicle, as payment in exchange for the second vehicle conceding ROW to the first vehicle.

Conceding ROW may comprise the second vehicle changing lanes to allow the first vehicle to pass, for example. In this manner, the first vehicle can, through payment of further tolls to other vehicles, travel along the congested roadway at a faster speed. Conversely, a second vehicle may travel along the congested roadway at a slower speed, in exchange for receiving payments of tolls from other faster moving vehicles.

The above advantages as well as other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic of a propulsion system for a vehicle, including an engine, energy storage device, fuel system, and motor;

FIG. 2 shows a schematic of an engine, including an exhaust-gas aftertreatment device.

FIG. 3 is a top view of a vehicle showing example locations of vehicle presence sensors.

FIG. 4 is a schematic illustrating an example configuration of an electronic control unit for performing V2V communication and tolling.

FIGS. 5-6 are example routines for performing V2V tolling.

FIGS. 7-13 are schematics illustrating example scenarios for performing V2V tolling.

FIG. 14 is a schematic illustrating examples of a threshold distance for V2V tolling.

FIG. 15 is a schematic illustrating an example configuration comprising a mobile device for handling road-use-dependent transactions.

### DETAILED DESCRIPTION

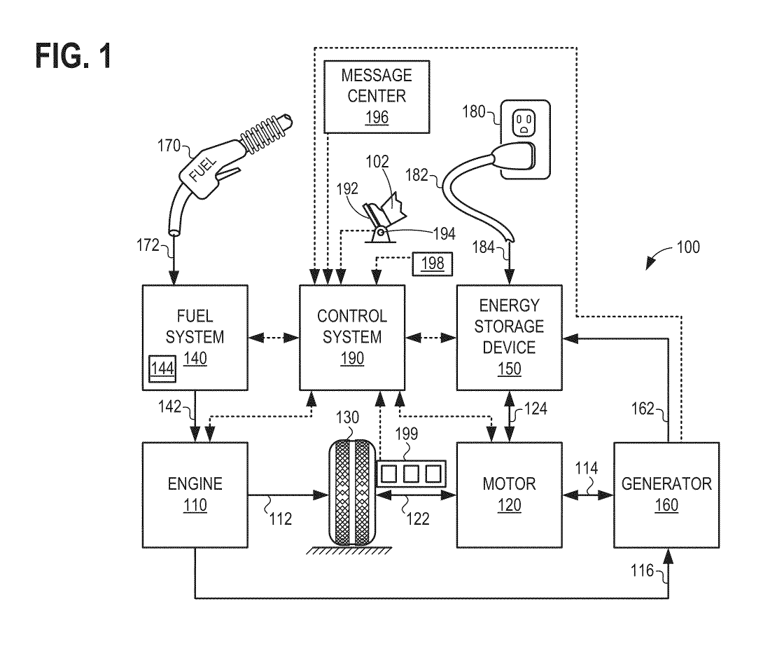

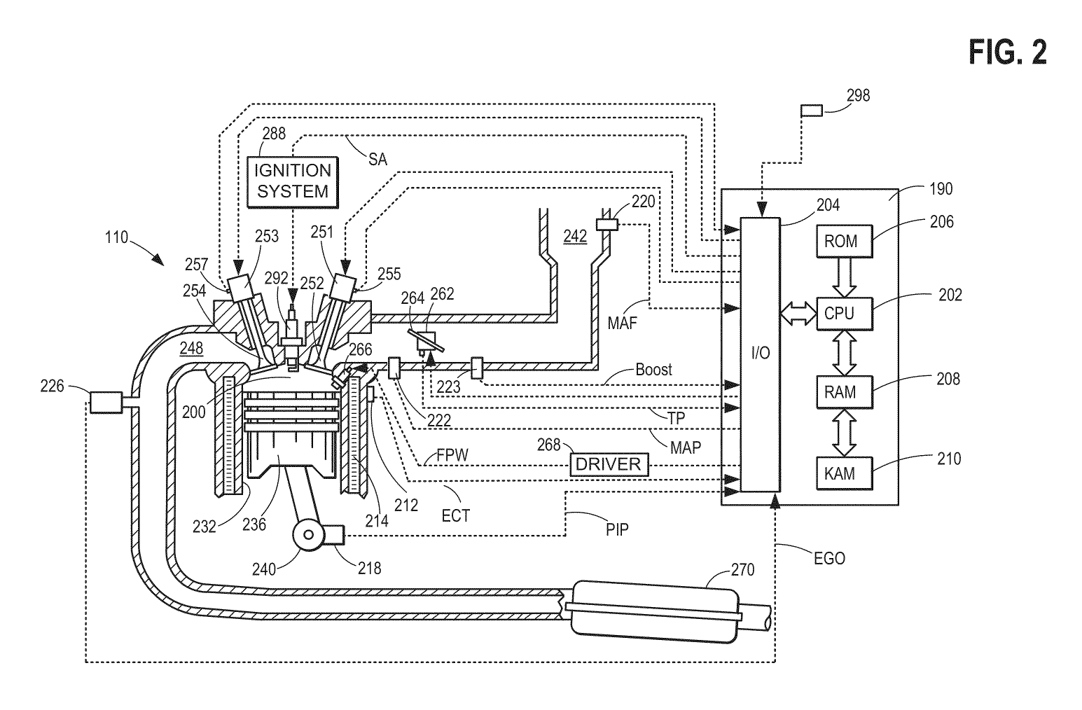

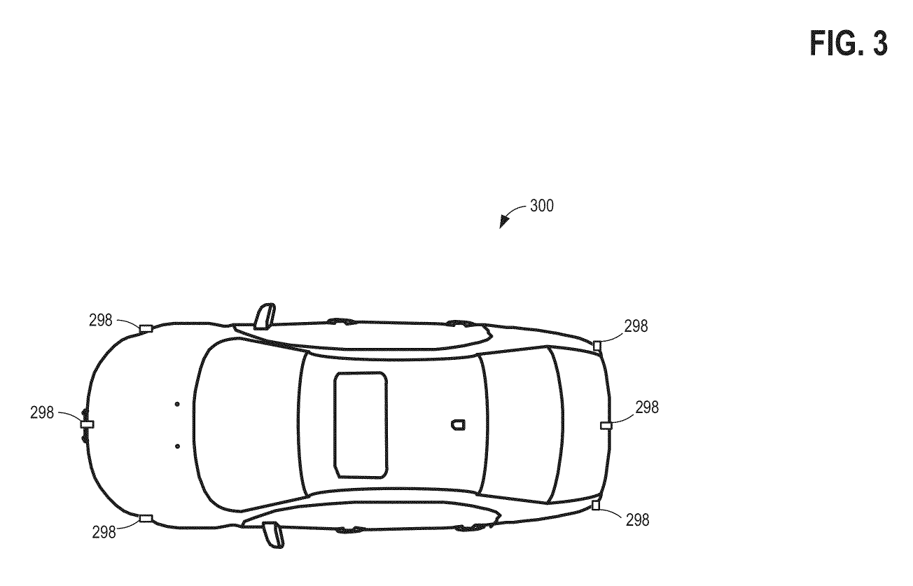

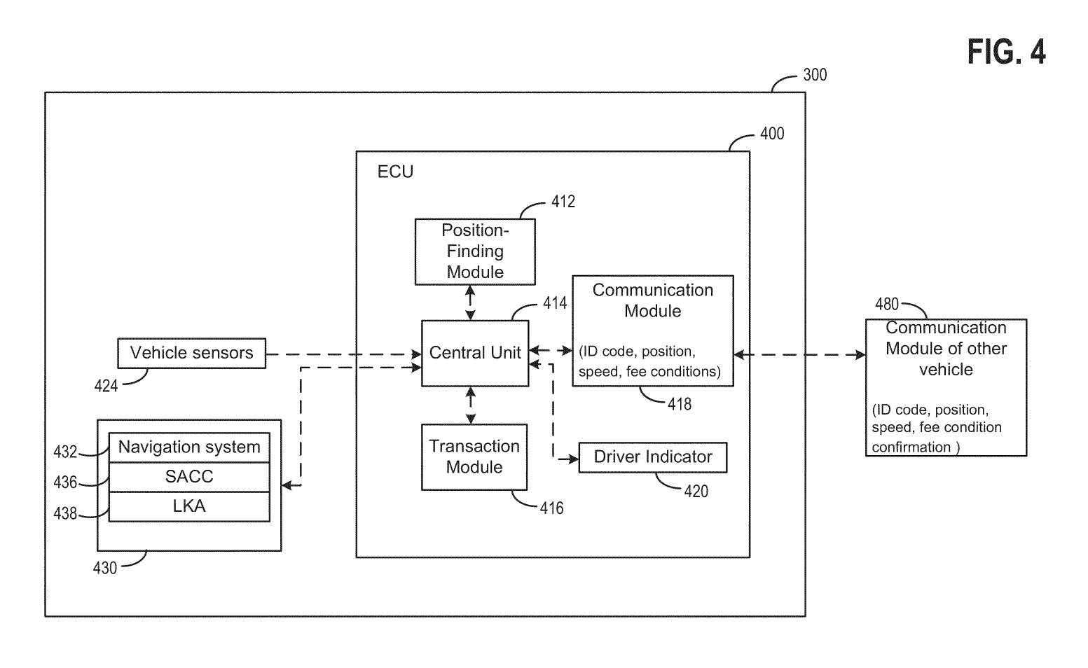

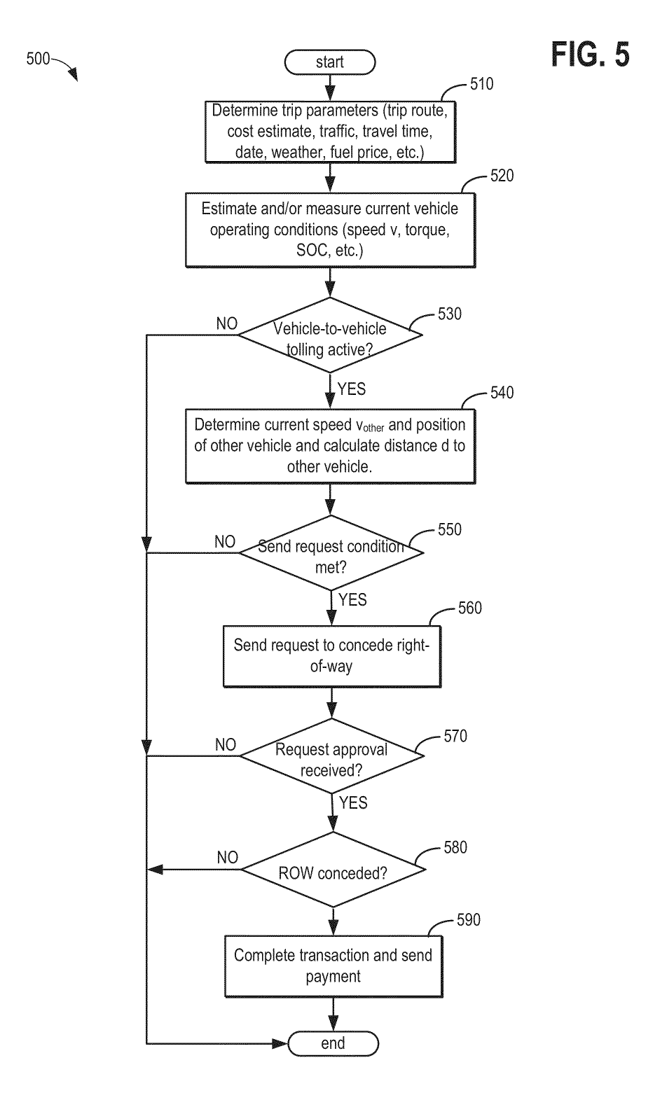

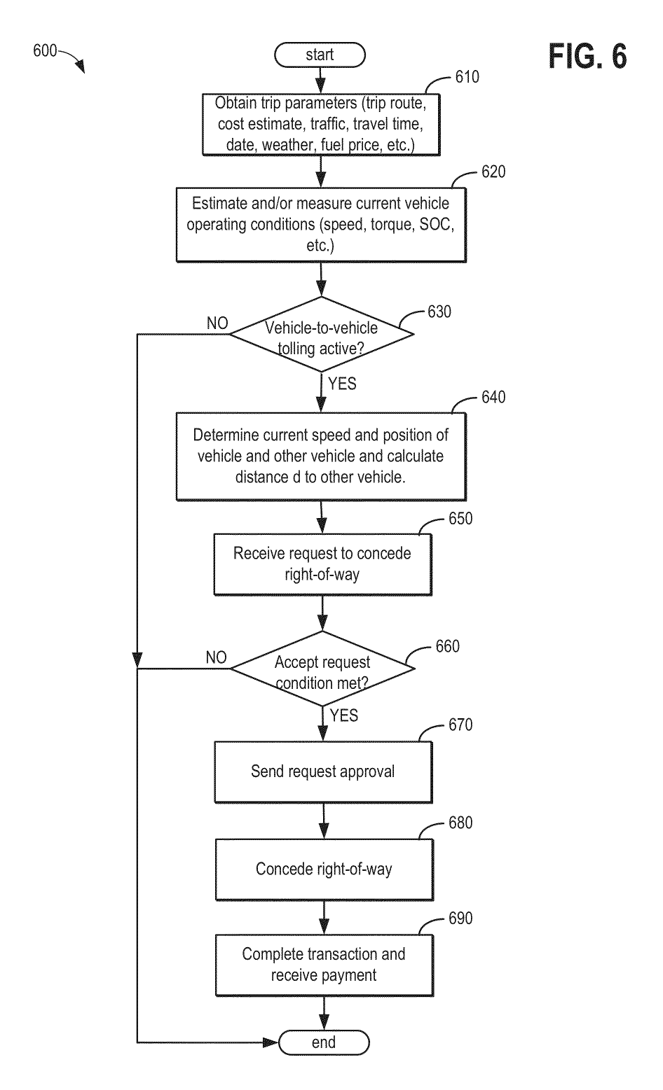

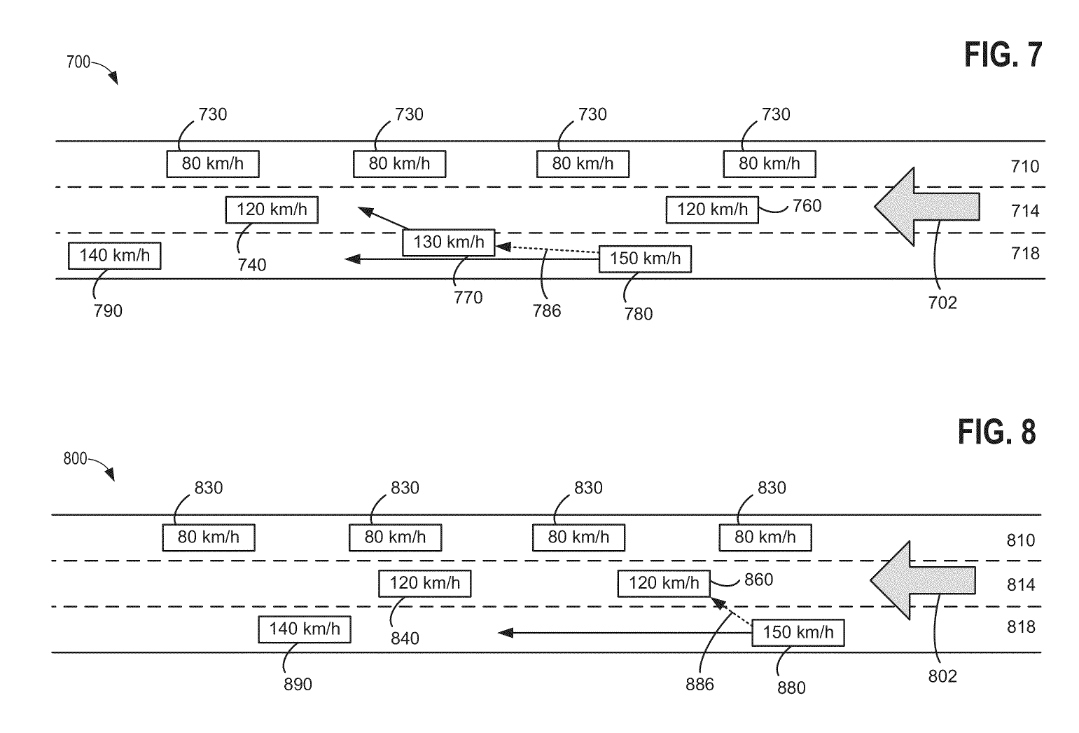

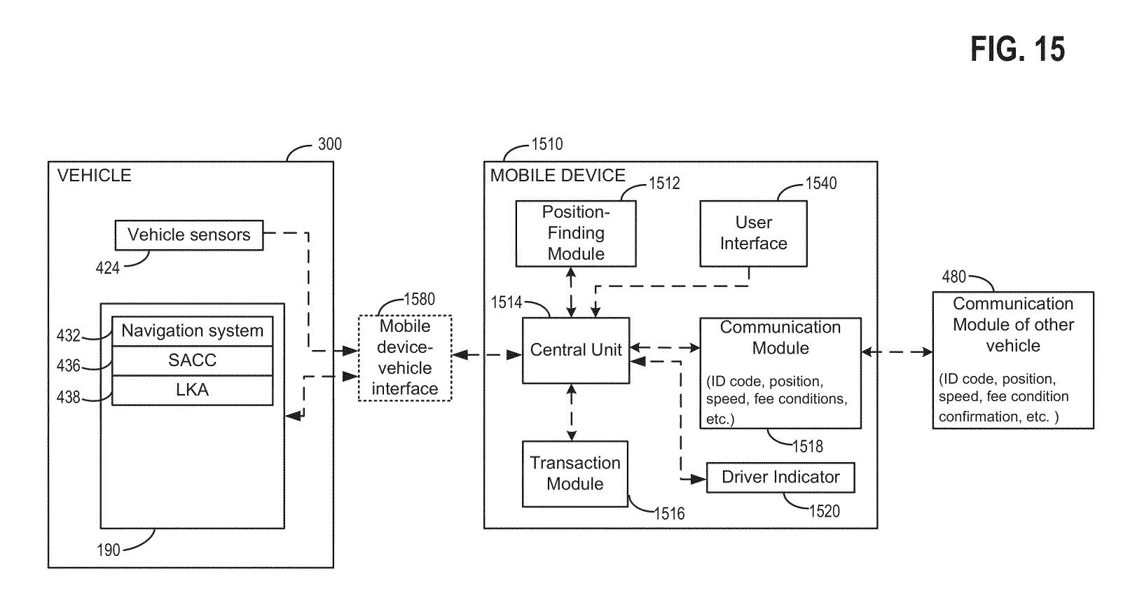

The description relates to a system and method for handling road-use-dependent financial transactions between vehicles, or (V2V) tolling. FIG. 1 illustrates an example of a propulsion system for a vehicle comprising an engine, motor, generator, fuel system and control system. FIG. 2 illustrates an example of an internal combustion engine, although the systems and method disclosed can be applicable to compression ignition engines and turbines, or motorized electric vehicles without a combustion engine. FIG. 3 illustrates example locations of vehicle presence sensors for detecting other vehicles and traffic in the vicinity of the vehicle. FIG. 4 illustrates an example configuration of an electronic control unit (ECU) for controlling the road-use-dependent financial transactions for V2V tolling between the host vehicle and the other vehicles. FIGS. 5 and 6 are flow charts that illustrate example routines for handling road-use-dependent financial transactions between vehicles, and FIGS. 7-13 are schematics that illustrate several different scenarios where road-use-dependent financial transactions may occur. FIG. 14 is a schematic illustrating V2V tolling threshold distance, and FIG. 15 is a schematic illustrating an example comprising a mobile device for handling V2V tolling.

Turning now to FIG. 1, it illustrates an example of a vehicle propulsion system 100. Vehicle propulsion system 100 may comprise a fuel burning engine 110 and a motor 120. As a non-limiting example, engine 110 comprises an internal combustion engine and motor 120 comprises an electric motor. As such, vehicle propulsion system 100 may be a propulsion system for a hybrid-electric vehicle. However, vehicle propulsion system may also be a propulsion system for a non-hybrid vehicle, or an electric vehicle with an electric motor and no combustion engine. Motor 120 may be configured to utilize or consume a different energy source than engine 110. For example, engine 110 may consume a liquid fuel (e.g., gasoline) to produce an engine output while motor 120 may consume electrical energy to produce a motor output. As such, a vehicle with propulsion system 100 may be referred to as a hybrid electric vehicle (HEV). In other examples, where the vehicle propulsion system 100 is for an electric vehicle, vehicle propulsion system may be referred to as an electric vehicle (EV).

Vehicle propulsion system 100 may utilize a variety of different operational modes depending on operating conditions encountered by the vehicle propulsion system. Some of these modes may enable engine 110 to be maintained in an off state (e.g. set to a deactivated state) where combustion of fuel at the engine is discontinued. For example, under select operating conditions, motor 120 may propel the vehicle via drive wheel 130 as indicated by arrow 122 while engine 110 is deactivated.

During other operating conditions, engine 110 may be set to a deactivated state (as described above) while motor 120 may be operated to charge energy storage device 150 such as a battery. For example, motor 120 may receive wheel torque from drive wheel 130 as indicated by arrow 122 where the motor may convert the kinetic energy of the vehicle to electrical energy for storage at energy storage device 150 as indicated by arrow 124. This operation may be referred to as regenerative braking of the vehicle. Thus, motor 120 can provide a generator function in some embodiments. However, in other embodiments, generator 160 may instead receive wheel torque from drive wheel 130, where the generator may convert the kinetic energy of the vehicle to electrical energy for storage at energy storage device 150 as indicated by arrow 162.

During still other operating conditions, engine 110 may be operated by combusting fuel received from fuel system 140 as indicated by arrow 142. For example, engine 110 may be operated to propel the vehicle via drive wheel 130 as indicated by arrow 112 while motor 120 is deactivated. During other operating conditions, both engine 110 and motor 120 may each be operated to propel the vehicle via drive wheel 130 as indicated by arrows 112 and 122, respectively. A configuration where both the engine and the motor may selectively propel the vehicle may be referred to as a parallel type vehicle propulsion system. Note that in some embodiments, motor 120 may propel the vehicle via a first set of drive wheels and engine 110 may propel the vehicle via a second set of drive wheels.

In other embodiments, vehicle propulsion system 100 may be configured as a series type vehicle propulsion system, whereby the engine does not directly propel the drive wheels. Rather, engine 110 may be operated to power motor 120, which may in turn propel the vehicle via drive wheel 130 as indicated by arrow 122. For example, during select operating conditions, engine 110 may drive generator 160, which may in turn supply electrical energy to one or more of motor 120 as indicated by arrow 114 or energy storage device 150 as indicated by arrow 162. As another example, engine 110 may be operated to drive motor 120 which may in turn provide a generator function to convert the engine output to electrical energy, where the electrical energy may be stored at energy storage device 150 for later use by the motor. The vehicle propulsion system may be configured to transition between two or more of the operating modes described above depending on vehicle operating conditions. As another example, vehicle propulsion system may be a propulsion system for an electric vehicle (e.g., with no combustion engine), wherein an electric motor receiving electric power from energy storage device 150 (e.g., a battery) may propel the vehicle.

Fuel system 140 may include one or more fuel tanks 144 for storing fuel on-board the vehicle. For example, fuel tank 144 may store one or more liquid fuels, including but not limited to gasoline, diesel, and alcohol fuels. In some examples, the fuel may be stored on-board the vehicle as a blend of two or more different fuels. For example, fuel tank 144 may be configured to store a blend of gasoline and ethanol (e.g. E10, E85, etc.) or a blend of gasoline and methanol (e.g. M10, M85, etc.), whereby these fuels or fuel blends may be delivered to engine 110 as indicated by arrow 142. Still other suitable fuels or fuel blends may be supplied to engine 110, where they may be combusted at the engine to produce an engine output. The engine output may be utilized to propel the vehicle as indicated by arrow 112 or to recharge energy storage device 150 via motor 120 or generator 160.

In some embodiments, energy storage device 150 may be configured to store electrical energy that may be supplied to other electrical loads residing on-board the vehicle (other than the motor), including cabin heating and air conditioning, engine starting, headlights, cabin audio and video systems, an exhaust-gas grid heater, an exhaust-gas recycle cooler, etc. As a non-limiting example, energy storage device 150 may include one or more batteries and/or capacitors.

Control system 190 may communicate with one or more of engine 110, motor 120, fuel system 140, energy storage device 150, and generator 160. As will be described in FIG. 2, control system 190 may comprise controller 211 and may receive sensory feedback information from one or more of engine 110, motor 120, fuel system 140, energy storage device 150, and generator 160. Further, control system 190 may send control signals to one or more of engine 110, motor 120, fuel system 140, energy storage device 150, and generator 160 responsive to this sensory feedback. Control system 190 may receive an indication of an operator requested output of the vehicle propulsion system from a Vehicle Operator 102. For example, control system 190 may receive sensory feedback from pedal position sensor 194 which communicates with pedal 192. Pedal 192 may refer schematically to a brake pedal and/or an accelerator pedal.

Energy storage device 150 may periodically receive electrical energy from a power source 180 residing external to the vehicle (e.g. not part of the vehicle) as indicated by arrow 184. As a non-limiting example, vehicle propulsion system 100 may be configured as a plug-in hybrid electric vehicle (HEV), whereby electrical energy may be supplied to energy storage device 150 from power source 180 via an electrical energy transmission cable 182. As a further non-limiting example, vehicle propulsion system 100 may be configured as a plug-in electric vehicle (EV), whereby electrical energy may be supplied to energy storage device 150 from power source 180 via an electrical energy transmission cable 182. Control system 190 may further control the output of energy or power from energy storage device 150 (e.g., a battery) depending on the electric load of vehicle propulsion system 100. For example, during reduced electrical load operation, control system 190 may step-down the voltage delivered from energy storage device 150, via a an inverter/converter, in order to save energy.

During a recharging operation of energy storage device 150 from power source 180, electrical transmission cable 182 may electrically couple energy storage device 150 and power source 180. While the vehicle propulsion system is operated to propel the vehicle, electrical transmission cable 182 may be disconnected between power source 180 and energy storage device 150. Control system 190 may identify and/or control the amount of electrical energy stored at the energy storage device, which may be referred to as the state of charge (state-of-charge).

In other examples, electrical transmission cable 182 may be omitted, where electrical energy may be received wirelessly at energy storage device 150 from power source 180. For example, energy storage device 150 may receive electrical energy from power source 180 via one or more of electromagnetic induction, radio waves, and electromagnetic resonance. As such, it will be appreciated that any suitable approach may be used for recharging energy storage device 150 from a power source that does not comprise part of the vehicle. In this way, motor 120 may propel the vehicle by utilizing an energy source other than the fuel utilized by engine 110.

Fuel system 140 may periodically receive fuel from a fuel source residing external to the vehicle. As a non-limiting example, vehicle propulsion system 100 may be refueled by receiving fuel via a fuel dispensing device 170 as indicated by arrow 172. In some embodiments, fuel tank 144 may be configured to store the fuel received from fuel dispensing device 170 until it is supplied to engine 110 for combustion.

A plug-in hybrid electric vehicle, as described with reference to vehicle propulsion system 100, may be configured to utilize a secondary form of energy (e.g. electrical energy) that is periodically received from an energy source that is not otherwise part of the vehicle.

The vehicle propulsion system 100 may also include a message center 196, ambient temperature/humidity sensor 198, electrical load sensor 154, and a roll stability control sensor, such as a lateral and/or longitudinal and/or steering wheel position or yaw rate sensor(s) 199. The message center may include indicator light(s) and/or a text-based display in which messages are displayed to an operator, such as a message requesting an operator input to start the engine, as discussed below. The message center may also include various input portions for receiving an operator input, such as buttons, touch screens, voice input/recognition, GPS device, etc. In an alternative embodiment, the message center may communicate audio messages to the operator without display. Further, the sensor(s) 199 may include a vertical accelerometer to indicate road roughness. These devices may be connected to control system 190. In one example, the control system may adjust engine output and/or the wheel brakes to increase vehicle stability in response to sensor(s) 199.

Referring now to FIG. 2, it illustrates a non-limiting example of a cylinder 200 of engine 110, including the intake and exhaust system components that interface with the cylinder. Note that cylinder 200 may correspond to one of a plurality of engine cylinders. Cylinder 200 is at least partially defined by combustion chamber walls 232 and piston 236. Piston 236 may be coupled to a crankshaft 240 via a connecting rod, along with other pistons of the engine. Crankshaft 240 may be operatively coupled with drive wheel 130, motor 120 or generator 160 via a transmission.

Cylinder 200 may receive intake air via an intake passage 242. Intake passage 242 may also communicate with other cylinders of engine 110. Intake passage 242 may include a throttle 262 including a throttle plate 264 that may be adjusted by control system 190 to vary the flow of intake air that is provided to the engine cylinders. Cylinder 200 can communicate with intake passage 242 via one or more intake valves 252. Cylinder 200 may exhaust products of combustion via an exhaust passage 248. Cylinder 200 can communicate with exhaust passage 248 via one or more exhaust valves 254.

In some embodiments, cylinder 200 may optionally include a spark plug 292, which may be actuated by an ignition system 288. A fuel injector 266 may be provided in the cylinder to deliver fuel directly thereto. However, in other embodiments, the fuel injector may be arranged within intake passage 242 upstream of intake valve 252. Fuel injector 266 may be actuated by a driver 268.

A non-limiting example of control system 190 is depicted schematically in FIG. 2. Control system 190 may include a processing subsystem (CPU) 202, which may include one or more processors. CPU 202 may communicate with memory, including one or more of read-only memory (ROM) 206, random-access memory (RAM) 208, and keep-alive memory (KAM) 210. As a non-limiting example, this memory may store instructions that are executable by the processing subsystem. The process flows, functionality, and methods described herein may be represented as instructions stored at the memory of the control system that may be executed by the processing subsystem.

CPU 202 can communicate with various sensors and actuators of engine 110, energy storage device 150, and fuel system 140 via an input/output device 204. As a non-limiting example, these sensors may provide sensory feedback in the form of operating condition information to the control system, and may include: an indication of mass airflow (MAF) through intake passage 242 via sensor 220, an indication of manifold air pressure (MAP) via sensor 222, an indication of throttle position (TP) via throttle 262, an indication of engine coolant temperature (ECT) via sensor 212 which may communicate with coolant passage 214, an indication of engine speed (PIP) via sensor 218, an indication of exhaust gas oxygen content (EGO) via exhaust gas composition sensor 226, an indication of intake valve position via sensor 255, an indication of exhaust valve position via sensor 257, an indication of electrical load via electrical load sensor 154, and an indication of oncoming traffic via one or more vehicle presence sensors 298, among others. For example, vehicle presence sensors 298 may include radar, laser, video, infrared, ultrasound, and image sensors, and/or combinations thereof to detect the presence of other vehicles in the vicinity of the vehicle. As an example, vehicle presence sensors may detect the presence of other vehicles travelling in the same lane, and in front of or behind the vehicle, including the trajectories and speeds of the other vehicles and the distances from the vehicle to the other vehicles. As a further example, vehicle presence sensors 298 may also detect the presence of other vehicles travelling in the adjacent lanes, in the vicinity of the vehicle, including the speeds and trajectories of the other vehicles are travelling and the distances from the vehicle to the other vehicles.

Furthermore, the control system 190 may control operation of the engine 110, including cylinder 200 via one or more of the following actuators: driver 268 to vary fuel injection timing and quantity, ignition system 288 to vary spark timing and energy, intake valve actuator 251 to vary intake valve timing, exhaust valve actuator 253 to vary exhaust valve timing, and throttle 262 to vary the position of throttle plate 264, among others. Note that intake and exhaust valve actuators 251 and 253 may include electromagnetic valve actuators (EVA) and/or cam-follower based actuators.

As an example, control system 190 may control the functions of several automated systems for the vehicle propulsion system 100 such as an Active Suspension System, Fuel Economy Management System, Collision Mitigation System, Electronic Stability Control (ESC) System, Roll Stability Control (RSC) System, Anti-Lock Braking System (ABS), Traction Control System (TCS), Lane Keeping Assistance (LKA) System, and the like. For example, the ABS may actuate the brake hydraulics to reduce hydraulic pressure and transmit brake pulsation to wheels that are rotating significantly slower than other wheels, to avoid impending wheel lock. As a further example, ESC system may sense that the vehicle has lost traction (e.g., skidding) when the intended vehicle direction determined through the steering angle does not match the actual vehicle direction of motion as determined through the lateral accelerometer, vehicle yaw, or individual wheel speeds. Accordingly, the ESC system may actuate the hydraulic brake actuators to apply the brakes to individual wheels to help return the actual vehicle direction of motion to that intended. ESC system may also work in conjunction with other systems such as TCS to mitigate loss of traction and to increase vehicle stability. For example, under slippery road conditions, TCS may limit the engine torque during vehicle acceleration to below a minimum traction torque threshold, above which TCS is triggered, so as to reduce traction or energy loss due to wheel spinning

Turning now to FIG. 3, it illustrates a top-view of a vehicle showing example positions of vehicle presence sensors 298 located around the vehicle periphery. For example, vehicle 300 may have one or more sensors 298 located in the vicinity of the front of the vehicle to detect vehicles ahead of vehicle 300, and travelling in the same lane or in lanes adjacent to vehicle 300. As a further example, vehicle 300 may have one or more sensors 298 located in the vicinity of the rear of the vehicle to detect vehicles behind vehicle 300, and travelling in the same lane or in lanes adjacent to vehicle 300. As a further example, vehicle 300 may have one or more sensors 298 located in the vicinity of either side of the vehicle to detect vehicles approximately alongside vehicle 300, and travelling in lanes adjacent to vehicle 300. In this manner, the positions of other vehicles in the vicinity of vehicle 300 may be detected by vehicle presence sensors 298. Furthermore, by tracking the positions of other vehicles in the vicinity of vehicle 300 over time, the speeds of other vehicles relative to the speed of vehicle 300 can be determined. Vehicle presence sensors 298 may also be used by an SACC system onboard the vehicle.

FIG. 3 illustrates example vehicle presence sensor positions, and is not meant to be limiting. As such, vehicle presence sensors may be located or installed at other locations in, on, around, or throughout the vehicle. Further still, controller 190 may use vehicle presence sensors along with other travel data such as traffic conditions, speed limits, trip route and calendar for initiating and responding to requests associated with road-use-dependent financial transactions.

Turning now to FIG. 4, it illustrates an example of an ECU 400 configured for controlling the road-use-dependent financial transactions between the host vehicle (e.g., vehicle propulsion system 100) and other vehicles. As an example, ECU 400 may reside on board the vehicle within control system 190 as part of CPU 202. ECU 400 may comprise a Position-Finding Module 412, Central Unit 414, Transaction Module 416, Communication Module 418, and Driver Indicator 420. The Central Unit may comprise a processing unit and memory for sending, receiving, processing and storing data, and may be configured to send and receive data from other components and modules of the ECU 400, vehicle sensors 424, and other vehicle systems 428.

Position-Finding Module 412 may determine the current position of the vehicle via a Global Positioning System (GPS) onboard the vehicle, and may communicate the GPS data to the Central Unit 414. Using the data received over time from the Position-Finding Module 412, Central Unit 414 may determine the trajectory and speed of the vehicle. Position Finding Module 412 may also determine the speed of the vehicle via the Central Unit 414 through communication with the SACC or CPU 202, for example.

Position-Finding Module 412 may further receive input from Central Unit 414 comprising data from Vehicle Sensors 424, including aforementioned sensors 199 and vehicle presence sensors 298. For example, Position-Finding Module 412 may determine the trajectories and speeds of other vehicles in the vicinity of the vehicle from the vehicle presence sensors 298 data received over time. Other vehicles in the vicinity of the vehicle may include other vehicles travelling in the same lane and in front of or behind the vehicle, as well as other vehicles travelling in lanes adjacent to the vehicle. Vehicle Sensors 424 may also include GPS sensors for determining travel route information such as traffic, weather, and speed limits along the travel route, as well as mapping alternate routes for reaching one or more trip destinations. Navigation System 432 may also provide travel route information.

Transaction module 416 may transmit and receive information to and from the Central Unit 414 for handling road-use-dependent transactions between the vehicle and other vehicles. The transactions may be financially based or points based, or may involve other types of road-use-dependent transactions. As such, Transaction Module 416 may store fee or toll amounts such as a sum of money or a number of points for transferring V2V tolls. The data stored by Transaction Module 416 may also be trip-based so that the total payments or receipts of V2V tolls during a particular trip can be determined. For example, if Transaction module 416 may also store information such as an identification code, account information, or security information related to the road-use-dependent transactions. For example, a financial road-use-dependent transaction may comprise the payment of a sum of money, pre-determined or otherwise, from a first vehicle gaining the ROW to a roadway, to a second vehicle conceding the ROW to the roadway to the first vehicle. As an alternative to a sum of money, the road-use-dependent transaction may also have other forms, for example the exchange of points. These points can be used, for example, in lieu of money in future road-use-dependent transactions.

Communication Module 418 may be configured for sending and receiving data to communicate with other vehicles. For example, data may be sent to and received from one or more communication modules 480 residing in another vehicle for conducting road-use-dependent transactions. For example, Communication Module 418 may send and receive vehicle identification codes, vehicle positions, vehicle speeds, and fee conditions related to road-use-dependent financial transactions associated with V2V tolling. Data may be sent and received via the Communication Module 418 in a wireless manner, for example, by using a wireless Car-to-Car (C2C) or V2V communications system such as a wireless local area network (WLAN).

Furthermore, a Driver Indicator module 420 may be provided in ECU 400 to communicate impending road-use-dependent transactions to the Vehicle Operator 102. For example, Driver Indicator 420 may communicate a request for completing a road-use-dependent transaction with another vehicle via a vehicle user interface such as message center 196 or via a wireless device such as a mobile phone, a laptop or a tablet computer. Furthermore, Vehicle Operator 120 may confirm or deny the request to complete a road-use-dependent transaction via a vehicle user interface such as message center 196 or wireless device.

Further still, Central Unit 414 may also communicate with other vehicle systems 430 such as a Navigation System 432, Smart Adaptive Cruise Control (SACC) System 436, and Lane Keeping Assistance (LKA) System 438, among others, for operating the vehicle based on impending road-use-dependent transactions, or in response to completed road-use-dependent transactions. For example, Central Unit 414 may receive the current traffic and maximum speed limit for the current travel route from the vehicle Navigation System 432, and the current vehicle speed from the SACC system 436. As a further example, Central Unit 414 may communicate with the SACC system 436 in preparation for overtaking (or being overtaken by) another vehicle, and SACC system 436 may increase (or decrease) the vehicle speed. As a further example, Central Unit 414 may communicate with the LKA system 438 when being overtaken by another vehicle, and in response, LKA system 438 may assist in steering the vehicle to change lanes safely. Central Unit 414 may further communicate with other vehicle systems such as traction control systems, rollover control systems, anti-lock brake systems, electronic stability control systems, parking assistance systems, and the like.

The configuration of ECU 400 shown in FIG. 4 may also be installed at a portable mobile device that can communicate with vehicle control system 190 (see FIG. 15). For example, Position-Finding module 412, Central Unit 414, Transaction Module 416, Communication Module 418, and Driver Indicator 420 may be installed, for example as an application, residing on a mobile device, such as a mobile telephone, laptop, or tablet computer. During operation of the vehicle, the mobile device may be connected (wirelessly or otherwise) via a mobile device-to-vehicle interface, such as a docking station, by Vehicle Operator 102 to the onboard vehicle systems. Data associated with the V2V tolling system may be sent and received at the mobile device associated with the vehicle of the Vehicle Operator 102. In this manner, the V2V tolling system and method can be associated with a mobile device and can be further associated with one or more vehicles operated by Vehicle Operator 102. GPS functions, access to WLAN or a cellular network, and handling of the road-use-dependent transaction (e.g., a financial transaction) may further be provided via the mobile device (e.g., a mobile phone).

In this manner a vehicle may comprise an engine, vehicle presence sensors, and a controller. The controller may comprise instructions executable to send a request from a first vehicle to a second vehicle to concede a right-of-way, receive a request approval from the second vehicle to concede the right-of-way, perform a road-use-dependent financial transaction based on the request approval, the controller comprising a communications module configured to communicate over a vehicle-to-vehicle communications network. The controller may further comprise instructions executable to receive a request from the second vehicle to concede the right-of-way, send a request approval to the second vehicle to concede the right-of-way, and perform a road-use-dependent financial transaction based on the request approval.

Turning now to FIG. 5, it illustrates a flow chart for an example method 500 of V2V tolling. Method 500 begins at 510 where trip parameters such as trip route, traffic conditions along the trip route, estimated travel time, current date, weather conditions, and fuel prices may be determined using Navigation System 332, vehicle GPS sensors, and other onboard vehicle sources such mobile devices. For example the GPS may provide traffic conditions along the planned trip route, indicating areas of high congestion, moderate congestion, light traffic and low traffic. An estimate of the trip cost may also be determined based on the trip length, estimated mileage for the trip route, traffic, fuel economy, fuel pricing, and the like. Method 500 continues at 520 where the current vehicle operating conditions such as speed v, torque, state-of-charge (SOC), and the like, are determined.

Next, method 500 continues at 530, where it determines if the vehicle's V2V tolling system is active. If the V2V tolling system is inactive, then method 500 ends. For example, the V2V tolling system may be inactive during conditions of low traffic because there is ample space on the roadway for vehicles to travel at their desired speed. Vehicle Operator 102 may also inactivate the V2V tolling system when the paying (or receiving) of V2V tolls is unwanted.

If the V2V tolling system is active, method 500 continues at 540 where the current speed, vₒₜₕₑᵣ, and position of another vehicle in the vicinity of vehicle 300 is determined. As described above, the presence of another vehicle in the vicinity of vehicle 300 can be determined using vehicle presence sensors 298. Furthermore, a distance, d from vehicle 300 to the other vehicle can be measured using the vehicle presence sensors 298. Based on the vehicle presence sensors 298, it can also be determined if the other vehicle is travelling in the same lane as vehicle 300 or in a lane adjacent to vehicle 300, and if the other vehicle is located ahead, behind, or beside vehicle 200. For example, it may be determined that vehicle 300 is travelling in a passing lane relative to the other vehicle. As another example, it may be determined that the other vehicle is travelling in the same lane directly ahead of vehicle 300.

Next, method 500 continues at 550, where it is determined if a send request condition is met. A send request condition may be a condition that indicates imminent overtaking of another vehicle. For instance the send request condition may be that the distance, d, to the other vehicle is less than a threshold distance, d_{threshold}. The threshold distance, d_{threshold} may indicate that vehicle 300 is approaching and about to overtake the other vehicle, for example, when v>vₒₜₕₑᵣ. Vehicle 300 may be referred to as an overtaking vehicle. For example, the threshold distance may correspond to a threshold time (e.g., based on the current relative speeds of vehicle 300 and the other vehicle) after which vehicle 300 will overtake the other vehicle. Accordingly, method 500 may determine d_{threshold} based on the relative speeds of vehicle 300 and the other vehicle corresponding to the threshold time. For example, if vehicle 300 is travelling at a higher speed than the other vehicle, d_{threshold} may be set higher as compared to the case where vehicle 300 is travelling at a speed slightly higher than that of the other vehicle.

The threshold distance may also depend on the lane in which another vehicle is travelling relative to vehicle 300. For example, if another vehicle is travelling ahead of vehicle 300 in the same lane, the threshold distance may be shorter than if another vehicle is travelling ahead of vehicle 300 in a lane adjacent to that of vehicle 300. FIG. 14 illustrates examples of threshold distance.

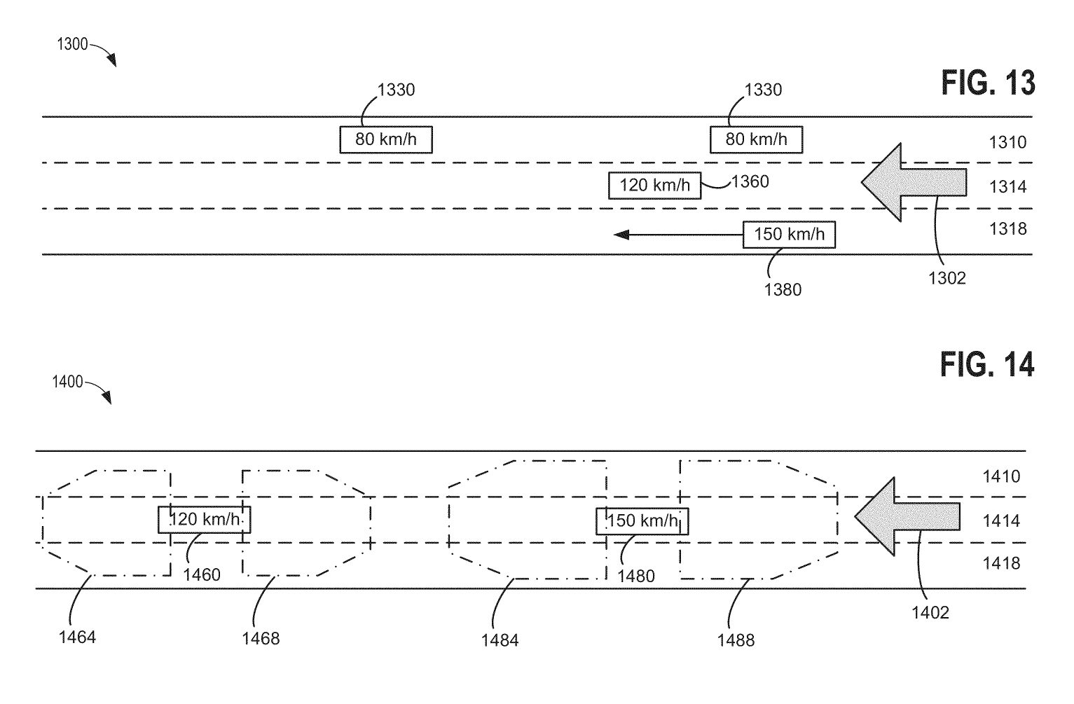

The send request condition may further comprise one or more other conditions. For example, if vehicle presence sensors onboard vehicle 300 detect that traffic ahead of vehicle 300 is very light, then the send request condition may not be met. FIG. 13 illustrates an example scenario for V2V tolling in light traffic conditions.

If the send request condition is not met, for example if d>d_{threshold}, method 500 ends. If the send request condition is met, for example if d<d_{threshold}, method 500 continues at 560, where a request is sent to the other vehicle to concede ROW to vehicle 300. Sending a request may further be performed automatically by the Communication Module 318 via the Central Unit 314, for example, when d<d_{threshold}. Automatically sending a request aids in maintaining the operability and drivability of the vehicle.

Sending a request may comprise sending a vehicle identification (ID) code, and the current vehicle position, and travel direction. The ID code may be used to identify the type of vehicle. For example, ID codes may specify that the vehicle is a cargo truck, passenger vehicle, public transportation vehicle, a government vehicle, a public works vehicle, and the like. Furthermore, the ID code may specify one or more owners of the vehicle, one or more V2V toll-related account holders associated with the vehicle. The ID code can then be used to send and receive toll payments to and from accounts associated with vehicles, such as accounts associated with one or more of the vehicle account holders. The ID code can further be associated with other attributes with vehicle 300.

Sending a request may further comprise sending the fee conditions for transferring a fee to an account associated with the other vehicle in exchange for conceding the ROW, for example, the fee amount and a payment date. In this manner a road-use-dependent transaction or V2V toll can be paid by vehicle 300 to the other vehicle if the other vehicle yields or concedes the ROW. The fee amount may be a predetermined fee amount, and may be determined based on several parameters. For example, the predetermined fee amount may depend on the current traffic conditions, the travelling speeds of the vehicles, and the speed limit of the roadway. As an example, the predetermined fee amount may be higher when the traffic conditions are heavier (as compared to when the traffic conditions are lighter) because conceding the ROW may result in a larger reduction in speed and longer delay of driving time for the other vehicle. As a further example, the predetermined fee amount may be higher when vehicle 300 is travelling much faster than the other vehicle as compared to when vehicle 300 is travelling slightly faster than the other vehicle. As a further example, the predetermined fee amount may be higher during rush hour as compared to non-rush hour times. Furthermore, the fee amount may be points-based or may be a monetary based fee. Points and money may be transferred or used to pay for and receive tolls when requesting concession of ROW or conceding ROW. The predetermined fee may further depend on the trip parameters. For example, if vehicle 300 is travelling behind schedule or if the estimated travel time to reach the destination is later than estimated, the fee amount may be adjusted higher than if the estimated travel time is on schedule.

Further still, the predetermined fee amount may be fixed, or may be adjusted by the Vehicle Operator 102. For example, Vehicle Operator 102 may increment the fee amount if a request to another vehicle to concede the ROW is not accepted (see below). Vehicle Operator 102 may adjust the fee amount via a user interface such as message center 196.

Under certain traffic conditions, no fee amount may be transferred from an account associated with the overtaking vehicle to an account associated with another vehicle. For example, no payment may be made when overtaking other vehicles that are travelling at the maximum speed limit of the roadway or faster because such vehicles are not disadvantaged by conceding ROW to vehicle 300. Furthermore, no payment may be made when overtaking vehicles travelling slower than the speed limit or a minimum threshold speed when there is no traffic, or slower than traffic flow in the lane. In this manner, payments are not made when overtaking vehicles that are deliberately travelling slower than the traffic flow, for example when queuing or parking Vehicles travelling in carpool lanes may also not be eligible for receiving or paying V2V tolls. Further circumstances where payments may or may not be transferred are illustrated below in the description of FIGS. 5-13.

The payment date specifies the time at which the fee amount is transferred from an account associated with vehicle 300. For example the payment date may be specified as immediately following the conceding of ROW, or the payment date may be within 30 minutes of the current time, or the payment date may be set at regular intervals during the trip, or the payment date may be at the end of the trip, or just before the end of the day.

Vehicle 300 may send requests to another vehicle travelling ahead in the same lane, or another vehicle travelling in a lane adjacent to vehicle 300. For example, if vehicle 300 approaches another vehicle in the same lane from behind within d_{threshold}, vehicle 300 may send a request to the other vehicle to concede the ROW. As a further example, if vehicle 300 is driving in the passing lane, and approaches another vehicle in an adjacent slower (e.g., non-passing) lane within d_{threshold}, vehicle 300 may send a request to the other vehicle to concede the ROW. In the latter case, conceding ROW may comprise the other vehicle remaining in the slower-moving lane allowing vehicle 300 to overtake and pass the other vehicle.

Next, method 500 continues at 570, where it is determined if the request sent by vehicle 300 is accepted by the other vehicle. Request acceptance may be achieved when the other vehicle sends a request approval to vehicle 300. The request approval may comprise the ID code, position and travel direction of the other vehicle. The request approval sent by the other vehicle may further comprise sending a confirmation of the fee conditions, for example a payment request, to vehicle 300. If the request is not accepted, the other vehicle may send a payment rejection indicating that the fee conditions are rejected. Furthermore, if the request is not accepted, no request approval or confirmation of receiving the request may be sent. For example, vehicle 300 may wait a threshold wait time for a request approval after sending a request to another vehicle. If the threshold wait time elapses and no request approval is received, the request is not accepted. If the request is not accepted, method 500 ends.

If the request is accepted, method 500 continues at 580, where it is determined if the ROW is conceded. Vehicle 300 may determine if the ROW is conceded using vehicle sensors 324, including vehicle presence sensors 298. For example, if vehicle 300 is overtaking another vehicle in the passing lane, vehicle 300 may send a request to the other vehicle to concede the ROW. After the other vehicle has accepted the request, vehicle presence sensors 298 may detect that the other vehicle has performed a maneuver, for example changed lanes, and is no longer travelling ahead of vehicle 300 in the same lane within d_{threshold}, thereby conceding ROW.

As a further example, if vehicle 300 is travelling in the passing lane, and is overtaking another vehicle travelling in an adjacent slower-moving lane, vehicle 300 may send a request to the other vehicle to concede the ROW. Accordingly, the other vehicle may concede the ROW by remaining in the slower-moving lane and not changing lanes to the passing lane. Vehicle 300 may determine that the other vehicle has conceded the ROW using vehicle presence sensors 298 to determine that the other vehicle has remained in the slower-moving lane, and has not performed a maneuver to change lanes to the passing lane.

As a further example, conceding ROW may also comprise receiving an updated ID code, position and travel direction of the other vehicle. If ROW is not conceded, method 500 ends, and no transfer of the fee amount is made. As a further example, conceding ROW may further comprise vehicle 300 completing a maneuver of overtaking the other vehicle.

If ROW is conceded, method 500 continues to 590, where the road-use-dependent transaction is completed by transferring the fee amount by the payment date from an account associated with vehicle 300 to an account associated with the other vehicle. Completing the transaction may be performed by the Transaction Module 416 via Central Unit 414 and Communication Module 418. For example, the fee amount may be transferred immediately following the conceding of ROW by the other vehicle. 590 may also comprise, prior to transferring the fee amount by the payment date, vehicle 300 overtaking the other vehicle. For example, once vehicle 300 performs a maneuver to overtake or pass the other vehicle, and this maneuver is sensed by vehicle sensors (e.g. vehicle presence sensors 298), the fee amount may be transferred by the payment date. After 590, method 500 ends.

Turning now to FIG. 6, it illustrates a flow chart of another example method 600 of conducting road-use-dependent transactions such as V2V tolling. 610, 620, 630, and 640 of method 600 are the same as aforementioned 510, 520, 530, and 540 of method 500 respectively.

Following 640, method 600 continues at 650 where vehicle 300 receives a request from another vehicle to concede the ROW. Receiving a request may comprise receiving an ID code, position and travel direction of the other vehicle. Receiving a request may further comprise receiving fee conditions comprising a fee amount to be transferred to an account associated with vehicle 300 from the other vehicle as payment for conceding the ROW, and a payment date. Receiving a request may be handled automatically, for example by the SACC system 436 via Central Unit 414 and Communication Module 418, if vehicle is being controlled by SACC system 436. As another example, receiving a request may be handled by Driver Indicator 420 via Communication Module 480. After receiving a request at 650, Driver Indicator 420 may notify Vehicle Operator 102, for example, via message center 196, that a request has been received. Driver Indicator 420 may provide an audible and/or visual and/or haptic indication to the driver. For example when a request is received, message center 196 may flash a light, emit a beeping sound, or vibrate the driver's seat.

Next, method 600 continues at 660 where it determines if an accept request condition is met. The accept request condition may comprise one or more conditions and may be based on a combination of parameters, including trip parameters determined at 610 such as traffic conditions, travel time, trip cost, trip route, and operating conditions determined at 620 such as vehicle speed. For example, if traffic conditions are heavy and the travel time is longer than planned, Vehicle Operator 102 may choose not to accept the request. As a further example, the request may be accepted if the Vehicle Operator 102 is ahead of schedule and doesn't mind changing to a slower moving lane. Furthermore, the request may be accepted or declined by the Vehicle Operator 102 based on the fee amount of the request. For example, accepting multiple requests to concede ROW during a trip may allow the Vehicle Operator 102 to offset the total trip cost.

Further still, accepting requests while travelling may be automated by ECU 400. For example, before or during a trip, Vehicle Operator 102 may setup Central Unit 414 to accept requests based on one or more criteria (e.g. accept request conditions). The one or more criteria may include the predetermined fee, the speed limit of the roadway, and the vehicle speed. For example, Vehicle Operator 102 may setup the system to accept requests as long as the vehicle speed can be maintained within a threshold speed of the speed limit, and as long as the predetermined fee is above a threshold fee amount. Furthermore, Vehicle Operator 102 may, for example, choose to setup the system to accept all requests as long as the predetermined fee is above a certain amount. Further still, Vehicle Operator 102 may choose to setup the system to accept all requests during a trip until a particular total sum of tolls is received. Input from Navigation System 432 involving travel route and traffic may also be used to compute routes or portions of routes during which it is most efficient to accept requests. In this manner, requests can be automatically accepted or denied in a timely fashion, while maintaining drivability and operability of vehicle 300.

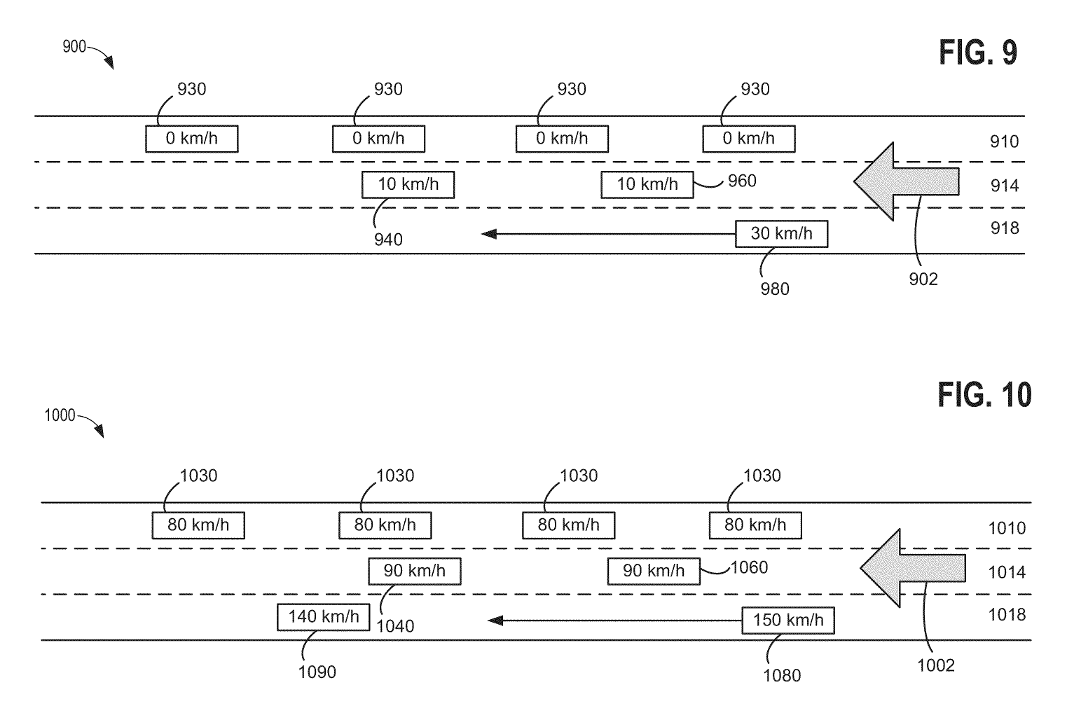

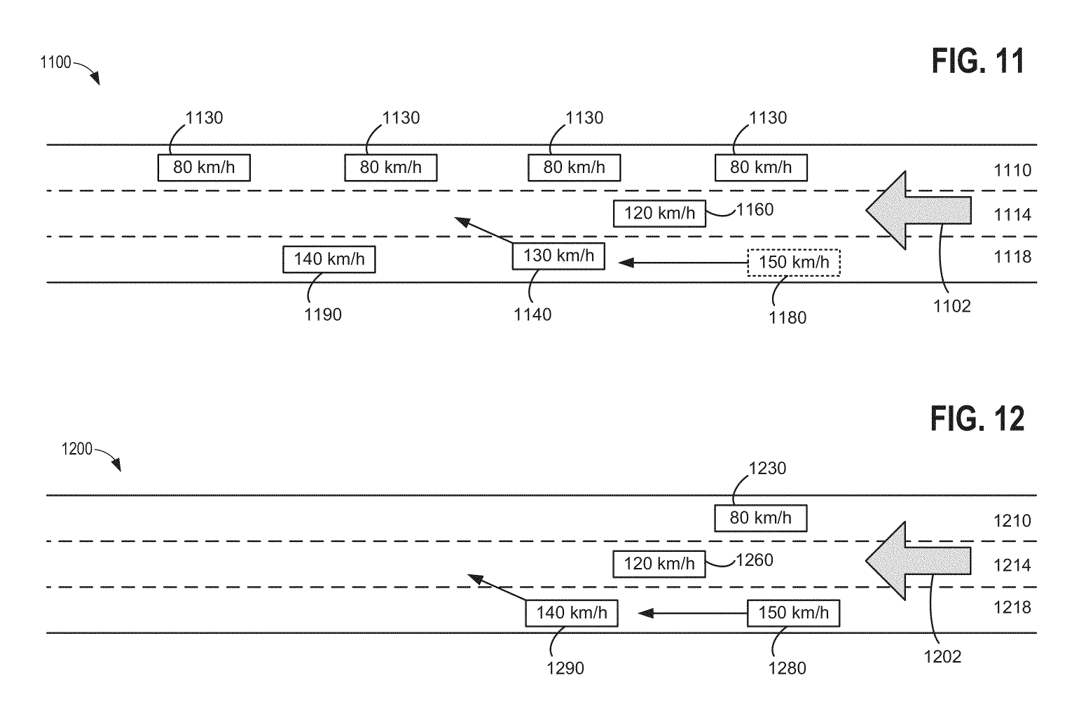

Further still, the accept request condition may further comprise additional conditions related to certain traffic conditions or vehicle operating conditions. For example, if vehicle 300 is parked or travelling below a minimum threshold speed, the accept request condition may not be met (see FIG. 9). Further still, if vehicle 300 is travelling at or above the maximum roadway speed limit, the accept request condition may not be met (see FIG. 10). Further still, if vehicle 300 is travelling below the speed of traffic, then the accept request condition may not be met (see FIGS. 11 and 12).

If the accept request condition is not met, a payment rejection may be sent to the other vehicle, or method 600 may end, without sending a payment rejection or a request approval. If the accept request condition is met, method 600 continues at 670 where a request approval is sent to the other vehicle to confirm the request and the fee conditions. Sending the request approval may comprise sending an ID code, a position, and a direction of travel of vehicle 300 to the other vehicle. Sending the request approval may further comprise sending a confirmation of the fee conditions (e.g., fee amount, payment date). Furthermore, if the accept request is met, a request approval may be sent before a threshold time has elapsed from receiving the request. Central Unit 414 may automatically send request approvals via Communication Module 418 after accept request conditions are met.

Next, method 600 continues at 680 where vehicle 300 concedes ROW to the other vehicle. Conceding ROW may comprise performing a maneuver comprising changing lanes to a slower-moving lane, or remaining in a slower-moving lane. In other words, completing the maneuver concedes ROW to the other vehicle. Vehicle systems comprising SACC 436 and LKA 438 may automatically perform the maneuver to concede ROW. For example SACC 436 may steer and accelerate or decelerate vehicle 300 using vehicle sensors 298 and the position of the other vehicle to change lanes to a slower-moving lane. As a further example, LKA 438 may aid in maintaining the direction of vehicle 300 in a slower-moving lane, thereby conceding ROW and allowing the other vehicle to pass.

Next, method 600 continues at 690 where the road-use-dependent transaction is completed by transferring the fee amount by the payment date from an account associated with the other vehicle to an account associated with vehicle 300. Completing the transaction may be performed by the Transaction Module 416 via Central Unit 414 and Communication Module 418. For example, the fee amount may be transferred immediately following the conceding of ROW by the vehicle 300. After 690, method 600 ends.

Vehicle systems comprising SACC 436 and LKA 438 may thus be used to assist ECU 400 to automatically perform (e.g. without intervention by the driver) sending and receiving requests to concede ROW, accepting requests, sending and receiving request approvals, determining when ROW is conceded, and sending and receiving payment and completing road-use-based financial transactions. A particular advantage of automating methods 500 and 600 is aiding in overall traffic flow while maintaining drivability and operability of the vehicle. For example, using methods 500 and 600, continual lane changing by drivers during heavy traffic is reduced because vehicles remain in slower-moving lanes in exchange for receiving toll payments, and overtaking vehicles may be granted ROW in an anticipatory fashion reducing occurrences of overtaking vehicles to slowing down and waiting for slower vehicles to change lanes.

In this manner, a method may comprise sending a request from a first vehicle to a second vehicle to concede a right-of-way to the first vehicle, in response to the request, receiving from the second vehicle a request approval for conceding the right-of-way, and in response to the request approval, transferring a fee to an account associated with the second vehicle. Sending a request may comprise sending to the second vehicle a first vehicle identification code, a first vehicle position, and a first vehicle direction of travel. Furthermore, sending the request is initiated automatically when a send request condition is met, the send request condition comprising the first vehicle approaching the second vehicle within a threshold distance. Sending a request may further comprise sending conditions for transferring the fee, the conditions comprising a fee amount and a payment date.

The method may further comprise receiving at the first vehicle a request approval from the second vehicle for conceding the right-of-way, the request approval comprising a second vehicle identification code, a second vehicle position, and a second vehicle direction of travel.

Transferring the fee may comprise transferring the fee amount using the identification code of the first vehicle and the identification code of the second vehicle before the payment date. Furthermore, transferring the fee amount may comprise transferring a predetermined fee amount, the predetermined fee amount determined based on one or more of a traffic condition in the first vehicle lane, a traffic condition in a second vehicle lane, roadway speed limit, the first vehicle speed, and the second vehicle speed. Further still, transferring the fee before the payment date may comprise transferring the fee amount immediately after the right-of-way is conceded.

The method may further comprise the first vehicle sending the request, receiving the request approval, and transferring the fee via a vehicle-to-vehicle wireless communications network. Furthermore, the threshold distance may be determined based on the relative speeds of the first vehicle and the second vehicle.

The method may further comprise receiving a request from another vehicle at the first vehicle to concede the right-of-way to the other vehicle, in response to the request from the other vehicle, sending to the other vehicle a request approval from the first vehicle for conceding the right-of-way, and receiving the fee amount from the other vehicle. Furthermore, conceding the right-of-way may comprise performing a maneuver, the maneuver comprising one or more of changing lanes to a slower-moving lane, and remaining in a slower-moving lane. Further still conceding the right-of-way may comprise automatically performing the maneuver using one or more of an adaptive cruise control system, a lane keeping assist system, and a navigation system onboard the first vehicle, based on the first vehicle position and the first vehicle direction of travel and a position of the other vehicle and a direction of travel of the other vehicle.

Sending the request approval from the first vehicle may comprise sending the first vehicle identification code, the first vehicle position, and the first vehicle direction of travel. Furthermore, sending the request approval from the first vehicle may comprise automatically sending the request approval when an accept request condition is met. Further still, the accept request condition may be based one or more of the predetermined fee, the roadway speed limit, the first vehicle speed, and a speed of the other vehicle.

In this manner a method may comprise generating a communication between a first vehicle and a second vehicle. Furthermore, in response to the communication and in response to a concession of right-of-way by a second vehicle, the method may further comprise generating a financial transaction in favor of the second vehicle.

Turning to FIGS. 7-13, they illustrate several different example scenarios where road-use-dependent financial transactions may occur. FIG. 7 illustrates an example multi-lane roadway 700, for example an expressway, comprising traffic lanes 710, 714, and 718, and traffic flow in the direction of arrow 702. Vehicles travelling on roadway 700 comprise vehicles 730 travelling at 80 km/h, vehicles 740 and 760 travelling at 120 km/h, and vehicles 770, 780 and 790 travelling at 130, 150, and 140 km/h respectively. It may be understood from FIG. 7 that 718 is a passing lane for faster-moving traffic, 714 is a slower-moving lane, and 710 is an even slower-moving lane, perhaps comprising where vehicles merge to enter the expressway. Furthermore, vehicles 730 may comprise public transportation vehicles. Furthermore, all vehicles are travelling below the maximum speed limit of the roadway with active V2V tolling systems.

In FIG. 7, vehicle 780 travelling at 150 km/h has approached vehicle 770 from behind. In this example, the distance between vehicles 770 and 780 may be less than a threshold distance, vehicle 780 may send a request to concede ROW to vehicle 770, and in response, vehicle 770 may send a request approval. Vehicle 770 begins conceding ROW to vehicle 780 by performing a maneuver to change lanes to slower-moving lane 714, reducing its speed to 120 km/h, and steering to a position between vehicles 740 and 760. In exchange for conceding ROW to vehicle 780, vehicle 770 may accept a payment of a fee amount from an account associated with vehicle 780 for transfer to an account associated with vehicle 770 once the lane change is complete. Transfer of the V2V toll fee amount is shown by dotted arrow 786. In this manner vehicle 780 may execute an overtaking maneuver and pass vehicle 770. Sending the request and sending the request approval may be initiated automatically via the active V2V tolling systems onboard vehicles 770 and 780 respectively using information from vehicle sensors, for example vehicle presence sensors 298. Furthermore, the overtaking maneuver may be executed automatically by vehicle systems such as an SACC or LKA system. In this manner, a V2V toll may be transferred from an account associated with vehicle 780 so that vehicle 780 may maintain a speed of 150 km/h.

In the example of FIG. 7, no payment is made to vehicles 730 because as public transportation vehicles, they may be required to travel in lane 710 or be limited to a lower speed. Furthermore, a transfer of a V2V toll may have already been made to an account associated with vehicle 760 as vehicle 780 has overtaken vehicle 760.

FIG. 8 shows another example of a multi-lane roadway, for example an expressway, comprising traffic lanes 810, 814, and 818, and traffic flow in the direction of arrow 802. Vehicles travelling on roadway 800 comprise vehicles 830 travelling at 80 km/h, vehicles 840 and 860 travelling at 120 km/h, and vehicles 880 and 890 travelling at 150, and 140 km/h respectively. It may be understood from FIG. 8 that 818 is a passing lane for faster-moving traffic, 814 is a slower-moving lane, and 810 is an even slower-moving lane, perhaps comprising where vehicles merge to enter the expressway. Furthermore, vehicles 830 may comprise public transportation vehicles. Furthermore, all vehicles are travelling below the maximum speed limit of the roadway with active V2V tolling systems.

In the example of FIG. 8, vehicle 880 is shown overtaking vehicle 860, which has conceded ROW to vehicle 880 by remaining in lane 814 and maintaining a lower speed of 120 km/h. As such, a V2V toll has been transferred from an account associated with vehicle 880, as indicated by 886, and vehicle 880 is able to maintain a speed of 150 km/h in lane 818. Payment of V2V tolls is made to vehicles remaining in a slower-moving lane so that vehicles in slower-moving lanes don't crowd faster moving lanes in order to receive payment of V2V tolls, thereby improving traffic flow. In the example of FIG. 8, no payment is made to vehicles 830 because as public transportation vehicles, they may be required to travel in lane 810 or be limited to a lower speed.

FIG. 9 shows another example of a multi-lane roadway 900, for example a city road, comprising traffic lanes 910, 914, and 918, and traffic flow in the direction of arrow 902. Vehicles travelling on roadway 900 comprise stationary vehicles 930, vehicles 940 and 960 travelling at 10 km/h, and vehicle 980 travelling at 30 km/h. It may be understood from FIG. 9 that 918 is a passing lane for faster-moving traffic, 914 is a slower-moving lane, and 910 is parking lane. Furthermore, vehicles 930 may comprise parked or queued vehicles, and vehicles 960 and 940 may be moving slowly (e.g., searching for parking) Furthermore, all vehicles are travelling below the maximum speed limit of the roadway with active V2V tolling systems.

In the example of FIG. 9, no transfer of V2V tolls are made as vehicle 980 overtakes vehicles 930 because they are stationary (e.g., parked or queuing). Similarly no transfer of V2V tolls is made to accounts associated with vehicles 940 and 960 respectively because they are travelling very slowly while looking for parking at 10 km/h, which may be below a minimum threshold speed. The minimum threshold speed may vary depending on the roadway, and may correspond to a minimum speed limit for the roadway. In the example of FIG. 9, the minimum threshold speed on a city road may be for example 20 km/h, whereas for an expressway the minimum speed limit may be 60 km/h, for example. In this manner, vehicle sensors aboard vehicles 930, 940, and 960 may determine that vehicles 930, 940, and 960 are stationary or travelling below the minimum threshold speed and thus their respective V2V tolling systems may not accept requests for V2V tolls. Furthermore, vehicle sensors aboard vehicle 980 may determine that vehicles 930, 940, and 960 are stationary or travelling below the minimum threshold speed, and thus may not send requests to those vehicles for transferring V2V tolls.

FIG. 10 shows another example of a multi-lane roadway 1000, for example an expressway with a maximum speed limit of 80 km/h, comprising traffic lanes 1010, 1014, and 1018, and traffic flow in the direction of arrow 1002. Vehicles travelling on roadway 1000 comprise vehicles 1030 travelling at the maximum speed limit of 80 km/h, vehicles 1040 and 1060 travelling above the maximum speed limit at 90 km/h, and vehicles 1080 and 1090 travelling at 150 km/h and 140 km/h respectively. It may be understood from FIG. 10 that 1018 is a passing lane for faster-moving traffic, 1014 is a slower-moving lane, and 1010 is a slowest lane for merging traffic. Furthermore, all vehicles are travelling with active V2V tolling systems.

In the example of FIG. 10 vehicle 1080 is shown overtaking numerous vehicles in 1010 and 1014. However, no V2V tolls would be transferred from an account associated with vehicle 1080 because vehicles in lanes 1010 and 1014 are all travelling at or above the maximum speed limit of the roadway. For example, the V2V tolling systems aboard vehicles 1030 and 1040 and 1060 may determine that those vehicles are travelling at or above the current roadway maximum speed limit and may not accept any transfer requests for V2V tolls from overtaking vehicles. As a further example, the V2V tolling system aboard vehicle 1080 may also, via vehicle sensors 298 for instance, determine that vehicles 1030, 1040, and 1060 being overtaken are travelling above the maximum speed limit and thus may not send requests for V2V tolls and conceding ROW.

The maximum speed limit on a roadway may also correspond to a particular vehicle type. For example trucks may have a lower maximum speed limit on a particular roadway than a passenger vehicle. Thus maximum speed limit associated with a vehicle may be identified during road-use-base transactions via the wireless V2V communications network using vehicle ID codes and roadway navigational or GPS data.

FIG. 11 shows another example of a multi-lane roadway 1100, for example an expressway, comprising traffic lanes 1110, 1114, and 1118, and traffic flow in the direction of arrow 1102. Vehicles travelling on roadway 1100 comprise vehicles 1130 travelling at 80 km/h, vehicle 1160 travelling at 120 km/h, and vehicles 1140, 1180 and 1190 travelling at 130 km/h, 150 km/h, and 140 km/h respectively. It may be understood from FIG. 11 that 1118 is a passing lane for faster-moving traffic, 1114 is a slower-moving lane, and 1110 is a slowest lane for merging traffic. Furthermore, all vehicles are travelling below the maximum speed limit of the roadway, and all vehicles have active V2V tolling systems except for vehicle 1180.

In the example of FIG. 11, vehicle 1180 (shown with dotted borders) has an inactive V2V tolling system. Vehicles with an inactive V2V tolling system may not send or receive requests for V2V tolls. Accordingly no V2V tolls are transferred from an account associated with vehicle 1180 even though vehicles 1140, 1160 and 1130 are shown conceding ROW to vehicle 1180.

FIG. 12 shows another example of a multi-lane roadway 1200, for example an expressway, comprising traffic lanes 1210, 1214, and 1218, and traffic flow in the direction of arrow 1202. Vehicles travelling on roadway 1200 comprise vehicles 1230 travelling at 80 km/h, vehicle 1260 travelling at 120 km/h, and vehicles 1280 and 1290 travelling at 150 km/h and 140 km/h respectively. It may be understood from FIG. 12 that 1218 is a passing lane for faster-moving traffic, 1214 is a slower-moving lane, and 1210 is a slowest lane for merging traffic. Furthermore, all vehicles are travelling below the maximum speed limit of the roadway with active V2V tolling systems.

In the example of FIG. 12 vehicle 1280 is shown overtaking vehicles 1290, 1230, and 1260. Nevertheless, because there are no other vehicles ahead of vehicles 1290, 1230, and 1260 in lanes 1218, 1210, and 1214 respectively, vehicles 1290, 1230, and 1260 are travelling more slowly than is possible. The lack of vehicular traffic may be detected by vehicle sensors, such as vehicle presence sensors 298 aboard vehicles 1290, 1230, and 1260. As such, V2V tolling systems aboard vehicles 1230 and 1260 may not accept requests for V2V tolling, for example from vehicle 1280 as it overtakes in lane 1218.

FIG. 13 shows another example of a multi-lane roadway 1300, for example an expressway, comprising traffic lanes 1310, 1314, and 1318, and traffic flow in the direction of arrow 1302. Vehicles travelling on roadway 1300 comprise vehicles 1330 travelling at 80 km/h, vehicle 1360 travelling at 120 km/h, and vehicle 1380 travelling at 150 km/h. It may be understood from FIG. 13 that 1318 is a passing lane for faster-moving traffic, 1314 is a slower-moving lane, and 1310 is a slowest lane for merging traffic. Furthermore, all vehicles are travelling below the maximum speed limit of the roadway with active V2V tolling systems.

In the example of FIG. 13, there is no vehicular traffic ahead of vehicle 1380 in lane 1318. As such, vehicle sensors, such as vehicle presence sensors 298, may detect that traffic ahead of vehicle 1380 is clear, and that traffic conditions are light. Accordingly, when overtaking vehicles in lanes 1310 and 1314, V2V tolling requests may not be sent from vehicle 1380.

Turning now to FIG. 14, it illustrates V2V tolling threshold distances for two vehicles 1460 and 1480 travelling at 120 km/h and 150 km/h respectively along a multi-lane roadway 1400, comprising traffic lanes 1410, 1414, and 1418, with traffic flow in the direction of arrow 1402. Vehicle sensors, for example vehicle presence sensors 298, may be used to sense the presence of other vehicles in the vicinity within a threshold distance. For example, regions 1464 and 1468 ahead and behind vehicle 1460 respectively may delineate be monitored by vehicle presence sensors 298 aboard vehicle 1460. If another vehicle is detected within region 1464, vehicle 1460 may detect approaching the other vehicle from behind and may initiate sending a V2V tolling request to that vehicle. If another vehicle is detected within region 1468, vehicle 1460 may detect the other vehicle approaching from behind and may prepare to receive a V2V tolling request. Regions 1484 and 1488 corresponding to vehicle 1480 may function analogously for vehicle 1480 as regions 1464 and 1468 function for vehicle 1460. Regions 1484 and 1488 are shown slightly larger for vehicle 1480 because vehicle 1480 is travelling faster than vehicle 1460. Accordingly the threshold distances associated with vehicle 1480 may be larger in order to correspond to the same threshold time for approaching and overtaking other vehicles as vehicle 1460. Further still, the threshold distance may be determined based on the relative speeds of a vehicle and the other vehicle. For example, if vehicle 1460 was travelling at 100 km/h, V2V tolling system onboard vehicle 1480 may detect the lower speed of vehicle 1460 via vehicle presence sensors 298, and may subsequently enlarge region 1484. As such, threshold distances may be higher under conditions when a vehicle is approaching another vehicle at a higher relative speed as compared to conditions when a vehicle is approaching another vehicle at a slightly higher relative speed. In other examples, a vehicle operator 102 also may choose to manually increase or decrease the threshold distance for their vehicle.

Turning now to FIG. 15, it illustrates an example configuration wherein systems and methods for handling road-use-dependent transactions for V2V tolling may be installed at a mobile device 1510, such as a mobile telephone, laptop, or tablet computer. Mobile device may communicate with vehicle control system 190 via a mobile device-vehicle interface 1580. For example, mobile device-vehicle interface 1580 may be a docking station or may be a wireless interface. The mobile device 1510 may communicate with vehicle controller via the mobile device-vehicle interface 1580 when the mobile device is located inside the vehicle.

Position-Finding module 1512, Central Unit 1514, Transaction Module 1516, Communication Module 1518, and Driver Indicator 1520 may be installed, for example as an application, residing on the mobile device. Furthermore, Vehicle Operator 102 may input provide input to the mobile device via User Interface 1540. User Interface 1540 may include a keyboard, touch screen, mouse, keypad, or other user input devices associated with mobile devices.

During operation of the vehicle 300, the mobile device 1510 may be connected (wirelessly or otherwise) via a mobile device-to-vehicle interface 1580 by Vehicle Operator 102 to the onboard vehicle systems (e.g. Navigation System 432, SACC 436, LKA 438, etc.) residing in control system 190. Furthermore, data from vehicle sensors 424 may be sent to Central Unit 1514 of mobile device 1510 via mobile device-vehicle interface 1580. Data associated with the V2V tolling system may be sent and received at the mobile device associated with the vehicle of the Vehicle Operator 102. In this manner, the V2V tolling system and method can be associated with a mobile device and can be further associated with one or more vehicles operated by Vehicle Operator 102. GPS functions, access to WLAN or a cellular network, other mobile device functions, and handling of the road-use-dependent transaction (e.g., a financial transaction) may further be provided via the mobile device (e.g., a mobile phone). For example, mobile device 1510 may communicate over a V2V communications network using Communication Module 1518 with Communication Module 480 of another vehicle for handling road-use-dependent financial transactions.

Further still, Position-Finding Module 1512, Central Unit 1514, Transaction Module 1516, Driver Indicator 1520 and Communications Module 1518 of mobile device 1510 may perform analogous functions to previously-described Position-Finding Module 412, Central Unit 414, Transaction Module 416, Driver Indicator 420 and Communications Module 418 of vehicle ECU 400 for handling road-use-dependent transactions such as V2V tolling.

In this manner, a mobile device may comprise a computer readable medium, with instructions executable to send a request from a first vehicle to a second vehicle to concede a right-of-way, receive a request approval from the second vehicle to concede the right-of-way, perform a road-use-dependent financial transaction based on the request approval, the mobile device comprising a communications module configured to communicate over a vehicle-to-vehicle network.

Note that the example process flows described herein can be used with various engine and/or vehicle system configurations. The process flows described herein may represent one or more of any number of processing strategies such as event-driven, interrupt-driven, multi-tasking, multi-threading, and the like. As such, various acts, operations, or functions illustrated may be performed in the sequence illustrated, in parallel, or in some cases omitted. Likewise, the order of processing is not necessarily called for to achieve the features and advantages of the example embodiments described herein, but is provided for ease of illustration and description. One or more of the illustrated acts or functions may be repeatedly performed depending on the particular strategy being used. Further, the described acts may graphically represent code to be programmed into the computer readable storage medium in the engine control system.

It will be appreciated that the configurations and routines disclosed herein are exemplary in nature, and that these specific embodiments are not to be considered in a limiting sense, because numerous variations are possible. The subject matter of the present disclosure includes all novel and non-obvious combinations and subcombinations of the various systems and configurations, and other features, functions, and/or properties disclosed herein.

The following claims particularly point out certain combinations and subcombinations regarded as novel and non-obvious. These claims may refer to “an” element or “a first” element or the equivalent thereof. Such claims are to be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application.

1. A method comprising:
sending a request from a first vehicle to a second vehicle to concede a right-of-way to the first vehicle;
in response to the request, receiving from the second vehicle a request approval for conceding the right-of-way; and
in response to the request approval, transferring a fee to an account associated with the second vehicle.

2. The method of claim 1, wherein sending a request comprises sending to the second vehicle a first vehicle identification code, a first vehicle position, and a first vehicle direction of travel.

3. The method of claim 2, wherein sending the request is initiated automatically when a send request condition is met.

4. The method of claim 3 wherein the send request condition comprises the first vehicle approaching the second vehicle within a threshold distance.

5. The method of claim 4, further comprising receiving at the first vehicle a request approval from the second vehicle for conceding the right-of-way, the request approval comprising a second vehicle identification code, a second vehicle position, and a second vehicle direction of travel.

6. The method of claim 5, wherein sending the request further comprises sending conditions for transferring the fee, the conditions comprising a fee amount and a payment date.

7. The method of claim 6, wherein transferring the fee comprises transferring the fee amount using the identification code of the first vehicle and the identification code of the second vehicle before the payment date.

8. The method of claim 7, wherein transferring the fee amount comprises transferring a predetermined fee amount, the predetermined fee amount determined based on one or more of a traffic condition in the first vehicle lane, a traffic condition in a second vehicle lane, roadway speed limit, the first vehicle speed, and the second vehicle speed.

9. The method of claim 8, wherein transferring the fee before the payment date comprises transferring the fee amount immediately after the right-of-way is conceded.

10. The method of claim 9, further comprising the first vehicle sending the request, receiving the request approval, and transferring the fee via a vehicle-to-vehicle wireless communications network.

11. The method of claim 3 wherein the threshold distance is determined based on the relative speeds of the first vehicle and the second vehicle.

12. The method of claim 10, further comprising:
receiving a request from another vehicle at the first vehicle to concede the right-of-way to the other vehicle;
in response to the request from the other vehicle, sending to the other vehicle a request approval from the first vehicle for conceding the right-of-way; and
receiving the fee amount from the other vehicle.

13. The method of claim 11, wherein conceding the right-of-way comprises performing a maneuver, the maneuver comprising one or more of changing lanes to a slower-moving lane, and remaining in a slower-moving lane.

14. The method of claim 12, wherein conceding the right-of-way comprises automatically performing the maneuver using one or more of an adaptive cruise control system, a lane keeping assist system, and a navigation system onboard the first vehicle, based on the first vehicle position and the first vehicle direction of travel and a position of the other vehicle and a direction of travel of the other vehicle.

15. The method of claim 13, wherein sending the request approval from the first vehicle comprises sending the first vehicle identification code, the first vehicle position, and the first vehicle direction of travel.

16. The method of claim 14, wherein sending the request approval from the first vehicle comprises automatically sending the request approval when an accept request condition is met.

17. The method of claim 14, wherein the accept request condition is based one or more of the predetermined fee, the roadway speed limit, the first vehicle speed, and a speed of the other vehicle.

18. A vehicle, comprising:
an engine;
vehicle presence sensors;
a controller, with instructions executable to:
send a request from a first vehicle to a second vehicle to concede a right-of-way;
receive a request approval from the second vehicle to concede the right-of-way; and
perform a road-use-dependent financial transaction based on the request approval, the controller comprising a communications module configured to communicate over a vehicle-to-vehicle communications network.

19. The vehicle of claim 18, wherein the controller further comprises instructions executable to:
receive a request from the second vehicle to concede the right-of-way;
send a request approval to the second vehicle to concede the right-of-way; and
perform a road-use-dependent financial transaction based on the request approval.

20. A mobile device, comprising:
a computer readable medium, with instructions executable to:
send a request from a first vehicle to a second vehicle to concede a right-of-way;
receive a request approval from the second vehicle to concede the right-of-way; and
perform a road-use-dependent financial transaction based on the request approval,
the mobile device comprising a communications module configured to communicate over a vehicle-to-vehicle network.

21. A method, comprising:
generating a communication between a first vehicle and a second vehicle; and
in response to the communication and in response to a concession of right-of-way by a second vehicle, generating a financial transaction in favor of the second vehicle.
